(19) United States
(12) Patent Application Publication
(10) Pub. No.: US 2026/0193070 A1
(43) Pub. Date: Jul. 9, 2026

(54) AERIAL WORK VEHICLE

(71) Applicant: TADANO UTILITIES LTD., Nagano (JP)

(72) Inventors: Yasuhisa TSUKAMOTO, Nagano (JP); Eiji GOZU, Nagano (JP); Longjun JIN, Nagano (JP); Kenji ARAI, Nagano (JP); Seiichi YUMOTO, Nagano (JP)

(21) Appl. No.: 19/131,684

(22) PCT Filed: Jan. 11, 2024
(86) PCT No.: PCT/JP2024/000351

§ 371 Date: May 21, 2025

(30) Foreign Application Priority Data
Jan. 31, 2023 (JP) 2023-012452
Jul. 26, 2023 (JP) 2023-121868

(51) Int. Cl. B66F 11/04

(52) U.S. Cl. CPC B66F 11/046

(57) ABSTRACT

It is an object of the present disclosure to provide an aerial work vehicle that can be fitted with a wheeled travel unit or a crawler-type travel unit on the same travel chassis according to the usage environment, including the state of the running surface, in order to reduce the vehicle cost and improve operating efficiency. As a solution, a travel unit (4) of an aerial work vehicle (1) is selectively combined, according to the usage environment, with: a wheeled travel unit (4A) in which connecting axles (4b2, 4c2) for holding wheels (4d) are detachably connected to first connecting portions (15) provided at intermediate positions on a front axle (4b) and a rear axle (4c) disposed on the travel chassis (4a); and a crawler-type travel unit (4B) in which track frames (4w), each of which supports a drive wheel (4u) and a driven wheel (4v) on which a crawler (4t) is suspended, are detachably connected to second connecting portions (16) provided on side surfaces of the travel chassis (4a).

### TECHNICAL FIELD

The present disclosure relates to an aerial work vehicle with a travel chassis to whose sides a wheeled travel unit with four wheels and a crawler-type travel unit with a pair of crawlers can be switchably attached.

### BACKGROUND ART

Working vehicles, such as aerial work vehicles, use an engine drive unit provided as a power source to drive a hydraulic pump and thereby run a travel unit equipped with crawlers, slew a vehicle body frame, and/or raise and lower a boom. Since aerial work is performed in a variety of environments, such as building sites and sites where maintenance work is required, aerial work vehicles that are suited to the task are used.

Travel units of aerial work vehicles come in two types, wheeled types and crawler types, with wheeled types being used on smoothed ground, such as paved roads, and crawler types being preferably used on uneven ground. Providing these two types of aerial work vehicle for use in keeping with the running surface increases the vehicle cost.

When a travel unit is switched from a wheeled type to a crawler type, the output rotational speed of the drive wheels will differ.

For this reason, a technology has been proposed where a reduction mechanism is provided with a plurality of axles with different rotational speeds, wheels are attached to axle(s) corresponding to large-diameter reduction gear, and drive sprockets are attached to an axle corresponding to a small-diameter reduction gear, with only the rear wheels being converted to a semi-crawler configuration (see Patent Document 1: Japanese Laid-open Patent Publication No. 2002-316675).

Other techniques have been proposed for replacing all four wheels of a small, four-wheeled truck with a semi-crawler type configuration (see Patent Document 2: U.S. Pat. No. 8,801,115, and Patent Document 3: U.S. Pat. No. 10,017,216).

A further technology has been proposed which, in order to convert a skid steer loader from a wheeled travel unit to a crawler-type travel unit, has mounting assemblies attached to the front and rear of both sides of the vehicle body frame so as to allow a switch to a crawler assembly where power is transmitted from the drive axle to a sprocket that rotates and drives crawlers (see Patent Document 4: US Patent Application Publication No. 2010-0060075).

### CITATION LIST

### Patent Documents

Patent Document 1: Japanese Laid-open Patent Publication No. 2002-316675
Patent Document 2: U.S. Pat. No. 8,801,115
Patent Document 3: U.S. Pat. No. 10,017,216
Patent Document 4: US Patent Application Publication No. 2010-0060075

### SUMMARY OF INVENTION

### Technical Problem

As mentioned earlier, if an aerial work vehicle provided with two types of travel unit, that is, a wheeled type and crawler type, which are used depending on the state of the running surface, the vehicle cost will increase. Also, if two or four of the wheels of a wheeled vehicle are changed to semi-crawler type structures, the conversion work will be time-consuming, which lowers the operating efficiency of the work vehicle. For a wheeled travel unit in particular, when running on an uneven surface, there can be cases where all four of the wheels are not grounded, which can destabilize the vehicle as it travels.

For a crawler-type travel unit, the links of the crawlers tend to stretch as they get older. When this happens, there is a risk of the crawlers slackening and coming off the drive wheels (sprocket wheels). When the front and rear wheels are changed to semi-crawler type structures, or when only the rear wheels are changed to a semi-crawler type structure, this will raise the vehicle's center of gravity and increase the contact pressure, which makes the vehicle unstable when traveling on uneven ground and prevents spin turns from being performed when changing direction at a narrow work site.

For an aerial work vehicle, there is no known technology for switching between a wheeled travel unit and a crawler-type travel unit in keeping with the state of the running surface. For an aerial work vehicle in particular which can be fitted with an engine drive unit or an electric drive unit as the drive source of the hydraulic unit, there is no known technology to switch between travel units in keeping with the usage environment, including the state of the running surface.

### Solution to Problem

The present disclosure was conceived to solve the problems described above and it is an object of the present disclosure to provide an aerial work vehicle that can be fitted with a wheeled travel unit or a crawler-type travel unit on the same travel chassis according to the usage environment, including the state of the running surface, in order to reduce the vehicle cost and improve operating efficiency.

To achieve the stated object, an aerial work vehicle according to an aspect of the present disclosure has the following configuration. That is, an aerial work vehicle can accommodate a worker in a basket provided at a front end of a raising/lowering boom and is capable of travelling, raising/lowering, and slewing operations, the aerial work vehicle including: a vehicle body frame including a hydraulic unit, which supplies hydraulic oil to each operated unit provided in a vehicle, and a main counterweight, which provides a stabilizing mass for a tipping mass that acts on the vehicle; a raising/lowering unit that is mounted on the vehicle body frame and is supplied with hydraulic oil by the hydraulic unit to raise and lower the raising/lowering boom and move the basket supported at a front end of the boom to a desired height; and a travel unit that supports the body frame so as to be capable of slewing and travels on a running surface, wherein the travel unit is switchably combined with: a wheeled travel unit in which connecting axles for holding wheels are detachably connected to first connecting portions provided at intermediate positions on a front axle and a rear axle disposed on the travel chassis; and a crawler-type travel unit in which track frames, each of which supports a drive wheel and a driven wheel on which a crawler is suspended, are detachably connected to second connecting portions provided on side surfaces of the travel chassis.

According to the above configuration, on smoothed ground such as paved roads, work can be carried out using the wheeled travel unit in which connecting axles for holding the wheels are detachably connected to the first connecting portions provided at intermediate positions on the front axle and the rear axle disposed on the travel chassis. In addition, on uneven ground such as a work site, the connecting axles that hold the wheels at the first connecting portions provided at intermediate positions on the front axle and the rear axle can be removed and replaced with the crawler-type travel unit in which track frames are detachably connected to second connecting portions provided on side surfaces of the travel chassis. In this way, by sharing the same travel chassis and switching between the wheeled and crawler-type travel units according to the usage environment, it is possible to reduce the vehicle cost and improve the operating efficiency of an aerial work vehicle.

In addition, by attaching and detaching the wheels at intermediate positions on the front and rear axles of the wheeled travel unit, there is no risk of interference between the front and rear axles and the crawlers, so that a crawler-type travel unit that has a wide contact area with the ground along the travel chassis can be installed.

Also, by replacing the wheeled travel unit, which is suited to use on smooth ground, with a crawler-type travel unit, which is suited to use on uneven ground, when it is necessary to perform aerial work on building sites and the like, it is possible to have low ground contact pressure and a low center of gravity, which improve running stability, and also possible to make spin turns in narrow spaces, which is expected to improve the efficiency of work.

As an alternative configuration, an aerial work vehicle can accommodate a worker in a basket provided at a front end of a raising/lowering boom and is capable of travelling, raising/lowering, and slewing operations, the aerial work vehicle including: a vehicle body frame including a hydraulic unit, which supplies hydraulic oil to each operated unit provided in a vehicle, and a main counterweight, which provides a stabilizing mass for a tipping mass that acts on the vehicle; a raising/lowering unit that is mounted on the vehicle body frame and is supplied with hydraulic oil by the hydraulic unit to raise and lower the raising/lowering boom and move the basket supported at a front end of the boom to a desired height; and a travel unit that supports the body frame so as to be capable of slewing and travels on a running surface, wherein the travel unit is switchably combined, at a same set of connecting portions provided on opposite surfaces of a travel chassis, with one of: a wheeled travel unit in which a front axle and a rear axle that hold wheels at both ends are respectively connected; and a crawler-type travel unit including track frames, each of which supports a drive wheel and a driven wheel on which a crawler is suspended.

According to the above configuration, on smooth ground such as paved roads, work can be carried out using a wheeled travel unit in which a front axle and a rear axle, which hold wheels at both ends, are connected to the same connecting portions provided on the opposite ends of the travel chassis. In addition, on uneven ground such as a work site, the front and rear axles can be removed from the same connecting portions provided at opposite sides of the travel chassis, and track frames that support drive wheels and driven wheels on which crawlers are suspended can be connected to convert the vehicle to a crawler-type travel unit which is then used to perform work. Accordingly, by sharing the same travel chassis and switching between a wheeled and a crawler-type travel chassis according to the usage environment, it is possible to reduce the vehicle cost and improve the operating efficiency of the aerial work vehicle.

In particular, since the wheeled travel unit and the crawler-type travel unit can be switchably installed at the same connecting portions on the travel chassis, the task of switching between travel units can be simplified.

In this crawler-type travel unit, it is preferable for each track frame to be composed of a plurality of frames that fit together and are connected by an adjust cylinder so as to be capable of extending and retracting, and for a spacing between the drive wheel and the driven wheel to be adjustable by operating the adjust cylinder. With this configuration, even if the crawler deteriorates over time and the links become stretched, which causes sagging, the tension of the crawler can be kept constant by using the adjust cylinder to adjust the spacing between the drive wheel and the driven wheel supported on the track frame, which prevents the crawler from coming off the drive wheel.

In the wheeled travel unit, it is preferable for a front swing axle and a rear swing axle to each be supported so as to be capable of swinging about swing shafts provided on the travel chassis, and for cylinder rods of a pair of swing cylinders supported on both sides of the travel chassis to be connected to both ends of the front swing axle and the rear swing axle.

With this configuration, even when the wheeled travel unit travels on an uneven road surface, the cylinder rods of the swing cylinders provided on both sides of the travel chassis will extend and retract, which causes the front swing axle and the rear swing axle to swing about the swing shafts, respectively, thereby maintaining a state where all four wheels are grounded so that a stable traveling operation can be maintained. During work, such as raising and lowering the raising/lowering unit, by stopping the supplying of hydraulic oil to the swing cylinders, the work can be performed in a state where any load (moment) generated by work, such as raising and lowering, is received by the four wheels that are grounded.

Travel motors may be connected to the wheeled travel unit and the drive wheels of the crawler-type travel unit.

In this way, by connecting travel motors to the wheeled travel unit and the drive wheels of the crawler-type travel unit, this simplifies the drive transmission mechanism, which increases the design freedom of the layout and configuration used to switch between the wheeled travel unit and the crawler-type travel unit on the travel chassis.

A counterweight may be mounted on a second mounting portion when an engine drive unit has been mounted on a first mounting portion of the vehicle body frame, and a battery may be mounted on the second mounting portion when an electric drive unit has been mounted on the first mounting portion.

With this configuration, it is possible to switch between the engine drive unit and the electric drive unit that serves as the power source of the hydraulic unit, to switch between a wheeled travel unit and a crawler-type travel unit that are engine-driven, and to switch between a wheeled travel unit and a crawler-type travel unit that are electrically driven, which makes it possible to further reduce the vehicle cost.

When the usage environment is a work site without electrical power supplying equipment, in high temperature environments where the outside temperature exceeds 40° C., and in low temperature environments where the outside temperature is 0° C. or below, it is possible to use an aerial work vehicle that includes the engine drive unit and is equipped with the wheeled travel unit or the crawler-type travel unit according to the state of the running surface. At indoor work sites where exhaust gas emissions are not permitted, in urban areas with noise regulations, or at nighttime work sites, it is possible to use an aerial work vehicle that includes the electric drive unit and is equipped with the wheeled travel unit or the crawler-type travel unit according to the state of the running surface. In this way, the same aerial work vehicle can be used to increase the variations of vehicle depending on the usage environment, including the state of the running surface, which improves usability, reduces the vehicle cost, and improves operating efficiency.

Between a front end portion of the raising/lowering boom and the basket, one of: a front end connecting mechanism in which a leveling bracket is rotatably connected to a boom front end block and which keeps the basket in a horizontal posture using a leveling cylinder that connects the boom front end block and the basket; and a front end jib connecting mechanism which, in addition to the front end connecting mechanism, has the basket connected via a pair of jib booms and a pair of jib links that are rotatably connected to the leveling bracket and in which the jib booms are raisable by a jib cylinder that connects the jib booms and the jib links, may be installed.

When there are no obstacles in the periphery of the workspace, aerial work can be performed with the front end connecting mechanism connected between the front end portion of the raising/lowering boom and the basket. If there are obstacles in the periphery that is the workspace or fine adjustment of the basket position is required, aerial work can be performed by connecting the front end jib connecting mechanism. By doing so, it is possible for the basket to easily pass over and go around obstacles, and also possible to perform fine adjustment of the basket position at height. Accordingly, it is possible to use the same aerial work vehicle, to improve variations of vehicle according to usage environment, and to improve operability of the basket at high positions, which is expected to improve usability, to reduce vehicle cost, and improve operating efficiency.

### Advantageous Effects of Invention

It is possible to provide an aerial work vehicle that can be fitted with a wheeled travel unit or a crawler-type travel unit on the same travel chassis according to the usage environment, including the state of the running surface, in order to reduce the vehicle cost and improve operating efficiency, and which can also be freely fitted with an engine-driven or electrically driven travel unit.

### BRIEF DESCRIPTION OF DRAWINGS

FIG. 1A is a front view, FIG. 1B is a plan view, and FIG. 1C is a left side view of an aerial work vehicle equipped with a wheeled travel unit.

FIG. 2A is a front view, FIG. 2B is a plan view, and FIG. 2C is a left side view of an aerial work vehicle equipped with a crawler-type travel unit.

FIG. 3 is a perspective view useful in explaining a wheeled travel unit according to a first embodiment.

FIG. 4 is a perspective view useful in explaining a dismantled state of the wheeled travel unit depicted in FIG. 3.

FIG. 5 is a perspective view useful in explaining an attached state of the wheeled travel unit depicted in FIG. 3.

FIGS. 6A and 6B are a plan view of a front axle depicted in FIG. 3 and a vertical cross-sectional view of a wheel part, and a plan view of the front axle and a horizontal cross-sectional view of the wheel part.

FIG. 7 is a perspective view useful in explaining a crawler-type travel unit according to a first embodiment.

FIG. 8 is a perspective view useful in explaining a dismantled state of the crawler-type travel unit depicted in FIG. 7.

FIG. 9 is a perspective view useful in explaining an attached state of the crawler-type travel unit depicted in FIG. 7.

FIG. 10 is a perspective view useful in explaining a wheeled travel unit according to a second embodiment.

FIG. 11 is a perspective view useful in explaining a dismantled state of the wheeled travel unit depicted in FIG. 10.

FIG. 12 is a perspective view useful in explaining an attached state of the wheeled travel unit depicted in FIG. 10.

FIG. 13 is a perspective view useful in explaining a crawler-type travel unit according to a second embodiment.

FIG. 14 is a perspective view useful in explaining a dismantled state of the crawler-type travel unit depicted in FIG. 13.

FIG. 15 is a perspective view useful in explaining an attached state of the crawler-type travel unit depicted in FIG. 13.

FIG. 16 is an overhead layout diagram depicting one example of switching between an engine drive unit and an electric drive unit on a vehicle body frame.

FIG. 17 is a diagram useful in explaining an example configuration of a hydraulic circuit where oil is supplied from the vehicle body frame to swing axle cylinders.

FIGS. 18A and 18B are diagrams useful in explaining a front end connecting mechanism and a front end jib connecting mechanism that are switched at a position between a raising/lowering boom and a basket according to a third embodiment.

FIGS. 19A to 19D are diagrams useful in explaining embodiments of a front end first connecting portion and a front end second connecting portion.

FIG. 20A is a front view, FIG. 20B is a plan view, and FIG. 20C is a left side view of a wheeled aerial work vehicle equipped with a front end jib connecting mechanism.

FIG. 21A is a front view, FIG. 21B is a plan view, and FIG. 21C is a left side view of a crawler-type aerial work vehicle equipped with a front end jib connecting mechanism.

FIG. 22 is a diagram useful in explaining variations in an aerial work vehicle, depicting a switch between an engine drive unit and an electric drive unit, a switch between a wheeled travel unit and a crawler-type travel unit, and a switch between a front end connecting mechanism and a front end jib connecting mechanism.

### DESCRIPTION OF EMBODIMENTS

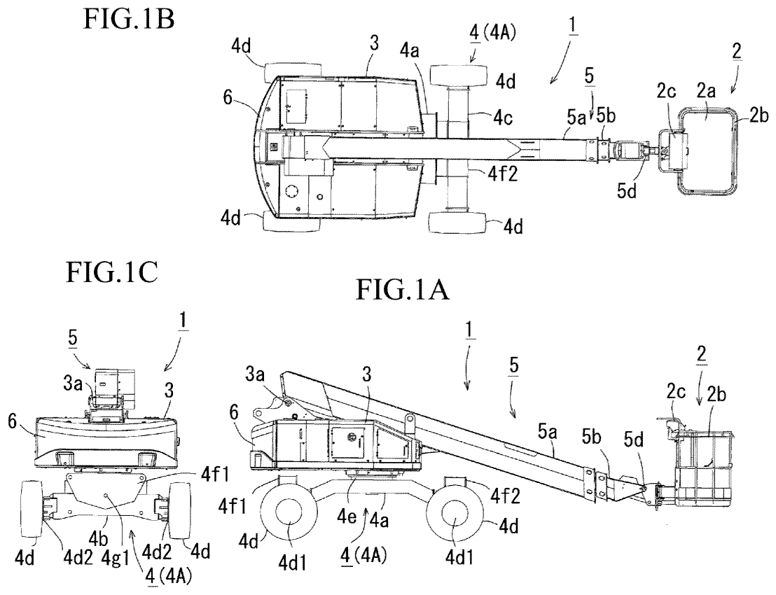

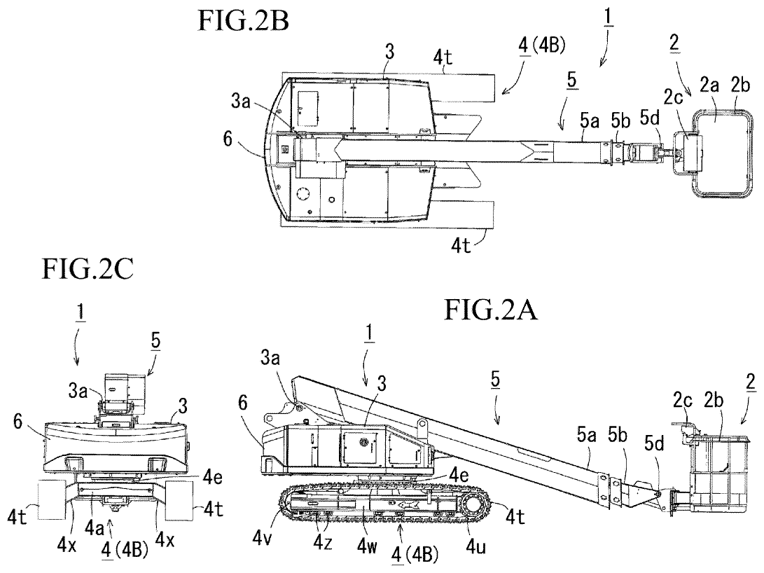

The overall configuration of an aerial work vehicle is described below with reference to FIGS. 1A to 1C and FIGS. 2A to 2C.

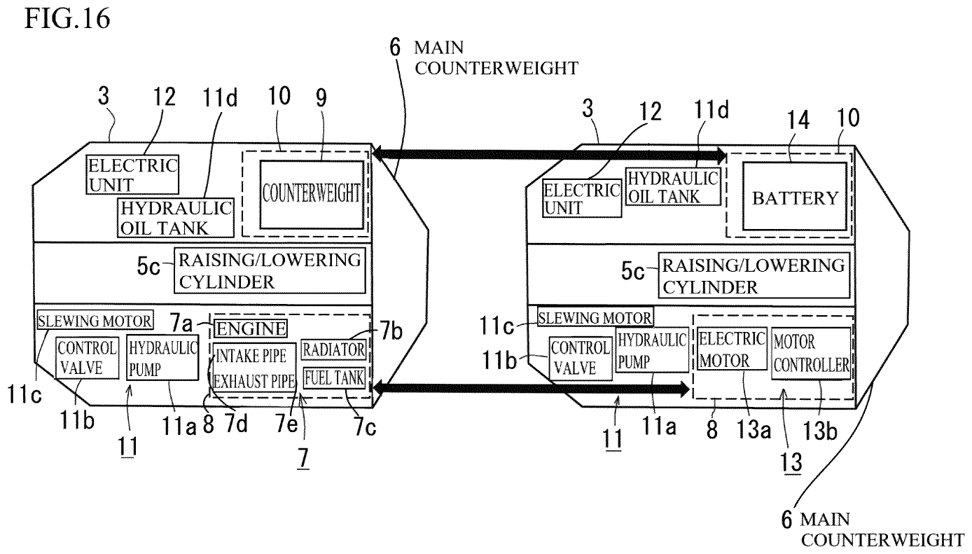

As depicted in FIG. 1A and FIG. 1B, the aerial work vehicle 1 is a work vehicle capable of travelling, raising and lowering, and slewing operations with a worker held in a basket 2 attached to the front end of a raising/lowering boom. The vehicle body frame 3 houses a hydraulic unit 11 (see FIG. 16) which as described later includes a power source, a hydraulic pump 11a driven by the power source, and a control valve 11b. As depicted in FIGS. 1A and 1C, the vehicle body frame 3 is mounted on the travel unit 4 so as to be capable of slewing. The travel unit 4 is a wheeled travel unit 4A. The wheeled travel unit 4A has wheels 4d rotatably supported at both ends of a front axle 4b disposed at the front in the length direction of a travel chassis 4a and at both ends of a rear axle 4c provided at the rear in the length direction. The travel unit 4 depicted in FIG. 2A and FIG. 2C is a crawler-type travel unit 4B. The crawler-type travel unit 4B includes a traveling chassis 4a which has track frames 4w, which each have a drive wheel (sprocket wheel) 4u and a driven wheel 4v at both ends and on which a crawler 4t is suspended, connected to both sides via connecting arms 4x.

A raising/lowering unit 5 is mounted on the vehicle body frame 3. The raising/lowering unit 5 is supplied with hydraulic oil from the hydraulic unit (see FIG. 16) and raises and lowers the raising/lowering boom, which moves the basket 2 supported at the front end of the boom to a desired height. As one example, as depicted in FIG. 1A and FIG. 2A, the raising/lowering unit 5 includes a first boom 5a, which can be raised, and a second boom 5b, which can be extended and retracted relative to the first boom 5a, in a concentric arrangement. The first boom 5a is connected to a raising/lowering cylinder 5c (see FIG. 16), with the first boom 5a being raised by rotating about a rotational shaft 3a.

As depicted in FIGS. 1A and 1B and FIGS. 2A and 2B, the basket 2 is connected to the front end of the second boom 5b via a link mechanism and a rotational shaft 5d. The basket 2 is configured to rotate about the rotational shaft 5d so as to maintain a horizontal posture even when the first boom 5a is raised and/or the second boom 5b extends or retracts relative to the first boom 5a. The worker in the basket 2 can raise and lower the basket 2 by operating the raising/lowering cylinder 5c so as to raise the first boom 5a through rotation about the rotational shaft 3a. The basket 2 can be further raised and lowered by operating an extending/retracting cylinder, not illustrated, to extend and retract the second boom 5b relative to the first boom 5a. By doing so, the operator can move the basket 2 to the desired height. Note that with a folding raising/lowering unit 5 where the first boom 5a and the second boom 5b are folded together via a connector portion, raising operations of the first boom 5a and raising operations of the second boom 5b may be performed by driving separate cylinders. Also, although a two-stage telescopic structure where the second boom 5b extends and retracts relative to the first boom 5a is used in the present embodiment, a boom that extends and retracts or bends in three or more stages may be provided.

As depicted in FIG. 1B and FIG. 2B, the basket 2 includes a floor surface 2a that supports a worker and a guard frame 2b that surrounds the floor surface 2a. The basket 2 includes an operation unit 2c (an operation handle, operation switches, operation levers, an operation panel, a display unit, and the like) that sends commands to operated units of the work vehicle. The raising/lowering unit 5 is mounted on the vehicle body frame 3. Although the raising/lowering unit 5 is disposed at the center in the width direction (a direction that is perpendicular to the front-rear direction) of the vehicle body frame 3 in the present embodiment, the raising/lowering unit 5 may instead be disposed at a position that is off-center to either side. A main counterweight 6 is provided at the front end (that is, the opposite end to the basket 2) of the vehicle body frame 3. The main counterweight 6 provides a stabilizing mass against a tipping mass that acts on the vehicle due to the basket 2, the raising/lowering unit 5, and the like.

Next, the internal structure of the vehicle body frame 3 will be described with reference to FIG. 16.

The left side of FIG. 16 depicts an example configuration of the vehicle body frame 3 that uses an engine drive unit 7 as a power source for the hydraulic unit 11. Note that the first boom 5a and the second boom 5b of the raising/lowering unit 5 mounted on the vehicle body frame 3 and the basket 2 have been omitted from FIG. 16. As depicted in the left side of FIG. 16, on the vehicle body frame 3, a first mounting portion 8 (one area surrounded by a dashed line in FIG. 16) on which the engine drive unit 7 is disposed and a second mounting portion 10 (another area surrounded by a dashed line in FIG. 16) on which the counterweight 9 is disposed are arranged on different sides of the raising/lowering unit 5 (indicated in the drawing as the raising/lowering cylinder 5c). The engine drive unit 7 includes an engine 7a, a radiator 7b, and a fuel tank 7c. The engine 7a is provided with an intake pipe 7d and an exhaust pipe 7e, which are connected to a combustion chamber, not illustrated.

As depicted on the left side of FIG. 16, the vehicle body frame 3 is provided with the hydraulic unit 11 as a shared unit. The hydraulic unit 11 includes a hydraulic pump 11a that pumps hydraulic oil, a control valve 11b that sends the hydraulic oil to each part of the vehicle, a slewing motor 11c that slews the vehicle body frame 3, and a hydraulic oil tank 11d that stores the hydraulic oil. In addition to the hydraulic unit 11, an electric unit 12 is also included as a shared unit. The electric unit 12 includes electrical components, such as a power supply, operation control, and various switches for each operated unit provided in the vehicle, together with terminal blocks for wiring purposes.

The right side of FIG. 16 depicts an example configuration of the vehicle body frame 3 that uses an electric drive unit 13 as a power source for the hydraulic unit 11. On the vehicle body frame 3, a first mounting portion 8 (one part surrounded by a dashed line in FIG. 16) where the electric drive unit 13 is disposed and the second mounting portion 10 (another part surrounded by a dashed line in FIG. 16) where a battery 14 is disposed are arranged on different sides of the raising/lowering unit 5 (indicated in the drawing as the raising/lowering cylinder 5a). The electric drive unit 13 includes an electric motor 13a, a motor controller 13b, and the like.

The electric drive unit 13 can be attached to the first mounting portion 8 of the vehicle body frame 3 in place of the engine drive unit 7. The battery 14 that acts as a balancing weight in place of the counterweight 9 can be attached to the second mounting portion 10. By reducing the weight of the engine drive unit 7 and the electric drive unit 13, which are interchanged, as much as possible in this way, the task of interchanging these units is made easier. Note that although the first mounting portion 8 and the second mounting portion 10 are arranged on different sides of the raising/lowering unit 5 (the raising/lowering cylinder 5c) on the vehicle body frame 3 in the present embodiment, the first mounting portion 8 and the second mounting portion 10 may both be disposed on one side of the raising/lowering unit 5.

In FIG. 16, when the engine drive unit 7 is attached to the first mounting portion 8, the counterweight 9 is attached to the second mounting portion 10, and when the electric drive unit 13 is attached to the first mounting portion 8, the battery 14 is attached to the second mounting portion 10. By doing so, the aerial work vehicle 1 equipped with an engine drive unit 7 in place of the electric drive unit 13 can be used in usage environments like those described below. As examples, the engine drive unit 7 is favorably used at work sites without electrical power supplying equipment, in high temperature environments where the outside temperature exceeds 40° C. (and electric components are prone to overheating and will need time to cool down, which extends the job time), and in low temperature environments where the outside temperature is 0° C. or below (and battery power drains quickly, which reduces the running time).

At indoor work sites where exhaust gas emissions are not permitted, in urban areas with noise regulations, or at nighttime work sites, the aerial work vehicle 1 can be used when equipped with the electric drive unit in place of the engine drive unit 7.

In this way, by using the same aerial work vehicle 1 and switching between the engine drive unit 7 and the electric drive unit 13 that serves as the power source in keeping with the usage environment, it is possible to reduce the vehicle cost. Note that the engine drive unit 7 and the electric drive unit 13 may be fixed to the vehicle body frame 3 and are not necessarily replaceable.

Since the counterweight 9 and the battery 14 that have an equivalent balancing effect are interchanged at the second mounting portion 10, it is possible to balance the vehicle so that the center of gravity position is unchanged before and after the unit at the first mounting portion 8 is interchanged. Note that the counterweight 9 and the battery 14 may be fixed to the vehicle body frame 3 and are not necessarily replaceable. Since the hydraulic unit 11 provided on the vehicle body frame 3 is shared, there is no need to change the hydraulic pipes connected to the hydraulic pump 11a when switching between power sources, which makes the task of switching units more efficient.

### First Embodiment

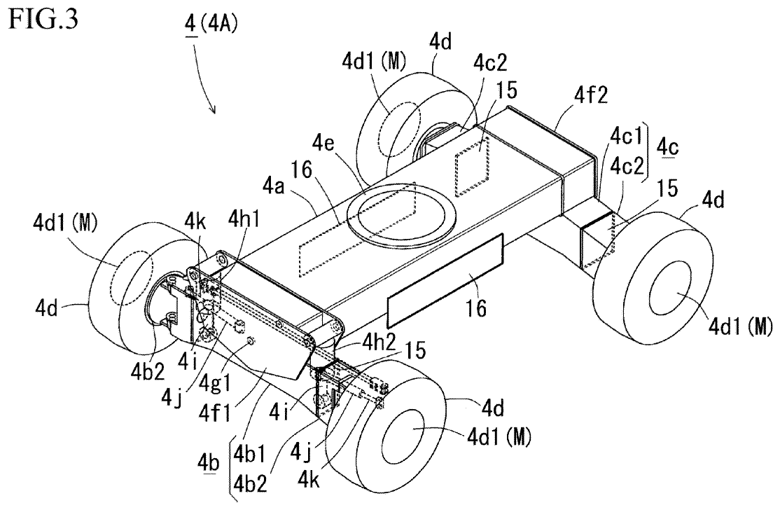

Next, one example of the wheeled travel unit 4A will be described with reference to FIG. 3 to FIG. 6. In FIG. 3, a slewing bearing 4e is provided on the upper surface of the traveling chassis 4a. The body frame 3 (see FIG. 1A) is mounted on the travel chassis 4a so as to be capable of slewing via the slewing bearing 4e. Mounting bases 4f1 and 4f2 are fixed to the front end and rear end in the length direction of the travel chassis 4a respectively. Swing shafts 4g1 and 4g2 (not illustrated) are provided in the center portions of such mounting bases 4f1 and 4f2, respectively. The front axle 4b is supported so as to be capable of swinging about the swing shaft 4g1, and the rear axle 4c is supported so as to be capable of swinging about the swing shaft 4g2. Note that the mounting bases 4f1 and 4f2 may be omitted, and in such case, the swing shafts 4g1 and 4g2 may be provided on the travel chassis 4a.

The front axle 4b has front connecting axles 4b2 detachably connected at first connecting portions 15 provided at both ends of a front swing axle 4b1. The wheels 4d are rotatably supported on these front connecting axles 4b2. A travel motor M is connected to (integrated into) a hub 4d1 of each wheel 4d. The rear axle 4c has rear connecting axles 4c2 detachably connected at first connecting portions 15 provided at both ends of a rear swing axle 4c1. The wheels 4d are rotatably supported on these rear connecting axles 4c2. A travel motor M is connected to the hub 4d1 of each wheel 4d.

As depicted in FIG. 3, a pair of swing cylinders 4h1, 4h2 are held on the left and right sides of each of the mounting bases 4f1 and 4f2 (this is not illustrated on the mounting base 4h2 side). Cylinder rods 4i of the swing cylinders 4h1 and 4h2 are connected to both ends of the front swing axle 4b1 and the rear swing axle 4c1, respectively. Note that when the mounting bases 4f1 and 4f2 are omitted, the swing cylinders 4h1 and 4h2 may be provided on both sides of the travel chassis 4a.

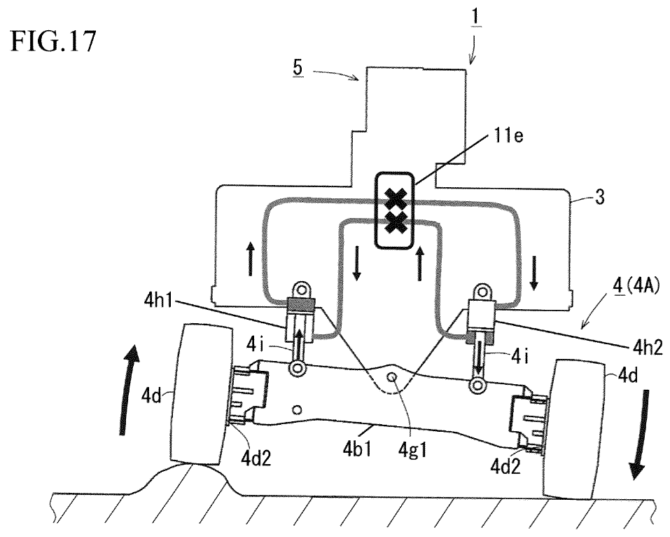

As depicted in FIG. 17, hydraulic oil is supplied to the pair of swing cylinders 4h1 and 4h2 from the hydraulic unit 11 provided inside the vehicle body frame 3, which causes the respective cylinder rods 4i to extend and retract. The supplying of hydraulic oil is stopped by controlling the opening and closing of a lock valve 11e provided in a hydraulic circuit.

By doing so, even when the wheeled travel unit 4A travels on an uneven road surface like that depicted in FIG. 17, the cylinder rods 4i of the swing cylinders 4h1 and 4h2 will extend and retract in response to the uneven surface, which causes the front swing axle 4b1 and the rear swing axle 4c1 to swing about the swing shafts 4g1 and 4g2, respectively, thereby maintaining a state where all four wheels are grounded so that a stable traveling operation can be maintained. During work, such as raising and lowering the raising/lowering unit 5, the lock valve 11e is closed to stop the supplying of hydraulic oil to the swing cylinders 4h1 and 4h2, so that any load (moment) generated by work, such as raising and lowering, is received by the four wheels that are grounded, which enables the work to be performed in a stable posture.

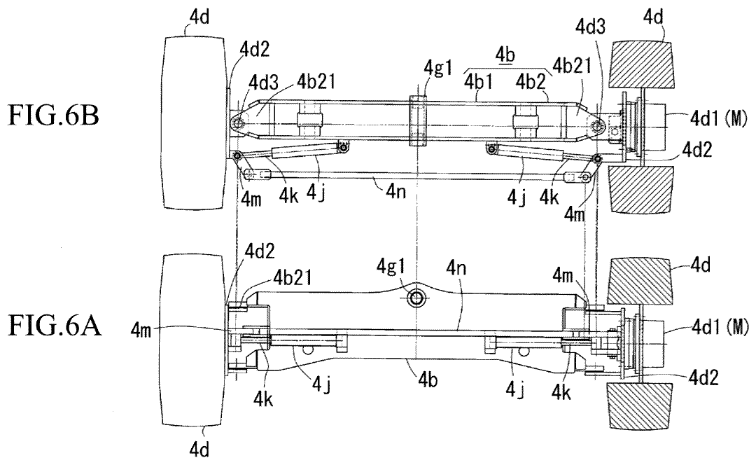

An example configuration for steering the wheels 4d provided on both ends of the front axle 4b will now be described with reference to FIGS. 6A and 6B. As depicted in FIGS. 6A and 6B, travel motors M are connected to the hubs 4d1 of the wheels 4d. Flange-shaped knuckles 4d2, which protrude from the hubs 4d1, are placed over flange portions 4b21 of the front connecting axles 4b2 and are connected so as to be rotatable around pins 4d3 that are vertically inserted. Knuckle arms 4m are provided to protrude from each of the left and right knuckles 4d2 (see FIG. 6B). A pair of steering cylinders 4j are supported on the left and right sides of the front swing axle 4b1. The pair of steering cylinders 4j each have a cylinder rod 4k connected to a knuckle arm 4m. A steering rod 4n is disposed in alignment with the front swing axle 4b1 and is connected at both ends to the knuckle arms 4m.

With this configuration, when a steering handle provided in the basket 2 is operated, hydraulic oil is supplied from the hydraulic unit 11 inside the vehicle body frame 3 to the pair of steering cylinders 4j, which causes one cylinder rod 4k to extend and the other cylinder rod 4k to retract. As a result, when the steering rod 4n moves in either the left or right directions, the left and right knuckles 4d2 rotate about the pins 4d3 via the knuckle arms 4m, which changes the orientations of the left and right front wheels 4d.

Note that in the present embodiment, the vehicle is configured with four-wheel drive by connecting drive motors M to the hubs 4d1 of all four wheels 4d. However, the vehicle may be configured to not have four-wheel drive, with the drive motors M being provided at only the front wheels 4d or at only the rear wheels 4d. The travel motors M may be hydraulic motors that are supplied with hydraulic oil from the hydraulic unit 11, or may be electric motors driven by power supplied from the battery 14.

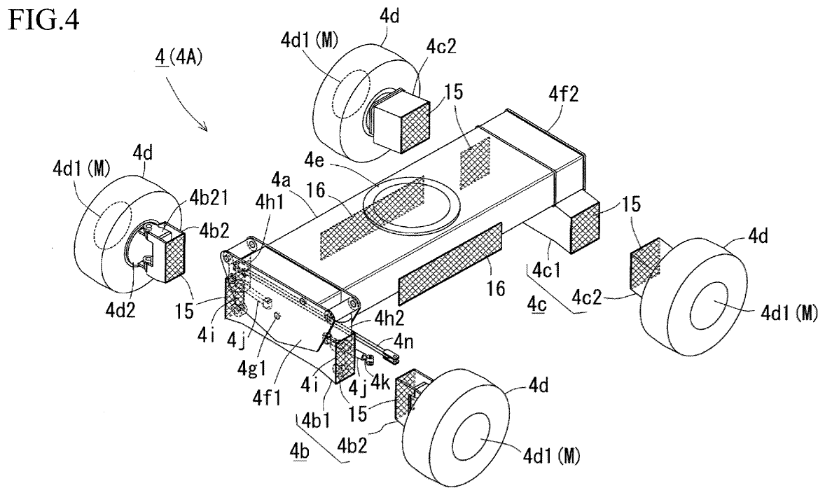

FIG. 4 depicts a state where the front swing axle 4b1 and the front connecting axles 4b2, which are provided at the front end in the length direction of the travel chassis 4a, are separated at the first connecting portions 15 and also a state where the rear swing axle 4c1 and the rear connecting axles 4c2, which are provided at the rear end in the length direction of the travel chassis 4a, are separated at the first connecting portions 15.

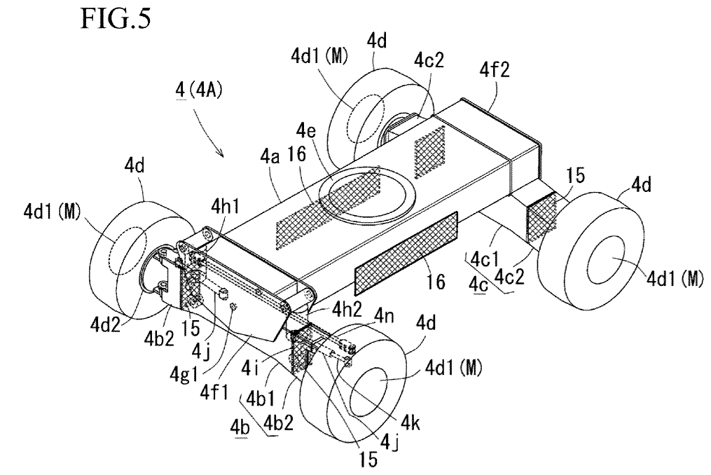

FIG. 5 depicts a state where the front swing axle 4b1 and the front connecting axles 4b2, which are provided at the front end in the length direction of the travel chassis 4a, are connected at the first connecting portions 15 and also a state where the rear swing axle 4c1 and the rear connecting axles 4c2, which are provided at the rear end in the length direction of the travel chassis 4a, are connected at the first connecting portions 15.

The connecting structure of the first connecting portions 15 may take various forms, as described below. It is preferable for the first connecting portions 15 to have a structure where at least flange portions, which are facing surfaces, are placed over each other. As examples, the flange portions may be placed over each other and fastened by threading bolts into bolt holes, or a clevis may be provided at facing flange portions which are connected and fastened with a pin. Alternatively, the flange portions may be connected by a combination of the above. The flange portions may be placed over each other, a bolt may be threaded into bolt holes, and hooks may be placed in engagement with engaged portions provided on the facing surfaces to connect the flange portions. As another configuration, the flange portions may be placed over each other, a bolt may be threaded into bolt holes, and claws may be inserted and placed in engagement with claw holes provided on the facing surfaces to connect the flange portions.

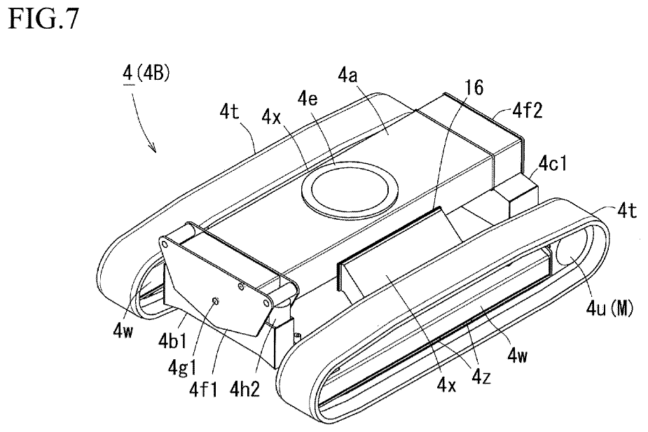

Next, an example of the crawler-type travel unit 4 will be described with reference to FIGS. 7 to 9. In FIG. 7, second connecting portions 16 are provided on both side surfaces of the travel chassis 4a. These second connecting portions 16 are used to replace the wheeled travel unit 4A with the crawler-type travel unit 4B. On uneven ground, such as a building site, the front connecting axle 4b2 that holds the wheels 4d and the rear connecting axle 4c2 that holds the wheels 4d are removed at the first connecting portions 15 provided in center portions of the front axle 4b and the rear axle 4c. Note that the steering cylinders 4j and the steering rod 4n may be removed as necessary. The task of fitting the crawler-type travel unit 4B, in which the track frames 4w are respectively connected to the second connecting parts 16 provided on both sides of the travel chassis 4a, is then performed. In more detail, the crawler-type travel unit 4B is connected to the travel chassis 4a at the second connecting portions 16 using the connecting arms 4x that extend from the track frames 4w. The connecting structures of the second connecting portions 16 are constructed with at least flange portions, which are facing surfaces, placed over each other in the same way as the connecting structures of the first connecting portions 15, and are not described in detail here.

In this way, by separately dismantling the front axle 4b and the rear axle 4c of the crawler-type travel unit 4B and attaching and detaching the wheels 4d, it is possible to install the crawler-type travel unit 4B that has a wide contact area along the length direction of the travel chassis 4a with no risk of interference between the front and rear axles 4b and 4c and the crawlers 4t.

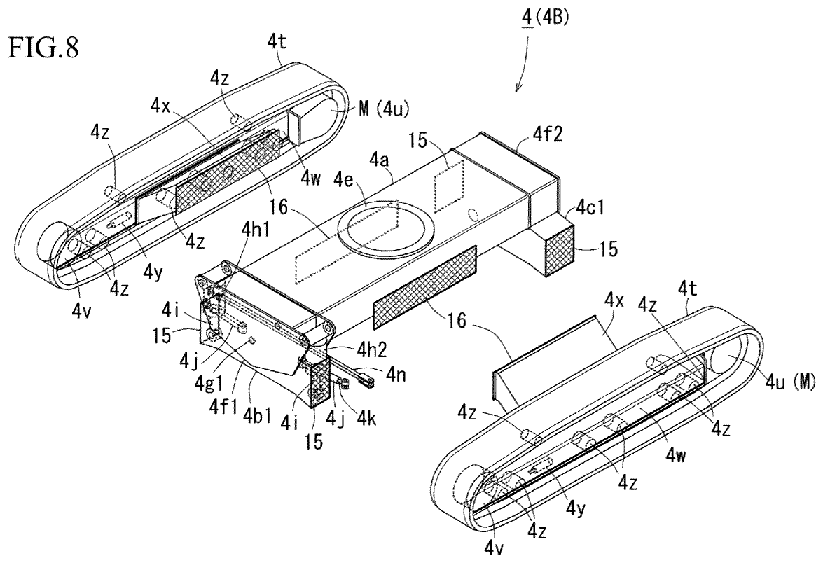

As depicted in FIG. 8, the crawler-type travel unit 4B has a drive wheel 4u and a driven wheel 4v rotatably supported at both ends of each track frame 4w. The crawlers 4t are suspended between the drive wheels 4u and the driven wheels 4v. Each track frame 4w is composed of a plurality of frames that fit together and are connected to each other by an adjust cylinder 4y so as to be capable of extending and retracting. By operating an adjust cylinder 4y, the spacing between a drive wheel 4u and a driven wheel 4v can be adjusted. A plurality of track rollers 4z are arranged along the length direction of each track frame 4w in contact with the inner peripheral surface of a crawler 4t so as to support the crawler 4t while being rotationally driven by the crawler 4t. With this configuration, even if the crawler 4t deteriorates over time and the links become stretched, which causes sagging, the tension of the crawler 4t can be kept constant by using the adjust cylinder 4y to adjust the spacing between the drive wheel 4u and driven wheel 4v supported on the track frame 4w, which prevents the crawler 4t from coming off the drive wheel 4u.

Note that in the present embodiment, each travel motor M is coaxially disposed on the hub of a drive wheel 4u. The travel motor M may be a hydraulic motor supplied with hydraulic oil from the hydraulic unit 11, or may be an electric motor driven by power supplied from the battery 14.

In this way, when the travel motors M are connected to the hubs of the wheels 4d of the wheeled travel unit 4A or the drive wheels 4u of the crawler-type travel unit 4B, this simplifies the drive transmission mechanism, which increases the design freedom of the layout and configuration used to switch between the wheeled travel unit 4A and the crawler-type travel unit 4B on the travel chassis 4a.

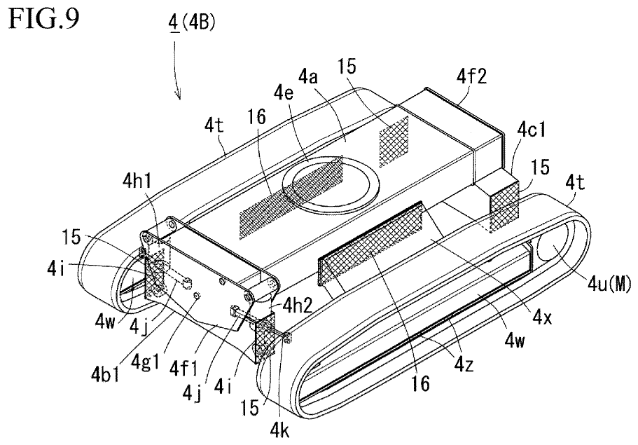

FIG. 8 depicts a state where the connecting arms 4x have been separated and the crawler-type traveling device 4B has been removed at the second connecting portions 16 provided on both side surfaces in the length direction of the travel chassis 4a. FIG. 9 depicts a state where the connecting arms 4x have been placed over the second connecting portions 16 provided on both side surfaces in the length direction of the travel chassis 4a to connect the crawler-type travel unit 4B. On a smoothed surface such as a paved road, the work of switching to the wheeled travel unit 4A can be performed by disconnecting the connecting arms 4x at the second connecting portions 16 to separate the crawler units and connecting the front connecting axles 4b2 and the rear connecting axles 4c2, which hold the wheels 4d, to the first connecting portions 15 provided at both ends of the front swing axle 4b1 and the rear swing axle 4c1 disposed on the travel chassis 4a (that is, locations midway along the front axle 4b and the rear axle 4c), (and as necessary also attaching the steering cylinders 4j and the steering rod 4n which were previously removed).

### Second Embodiment

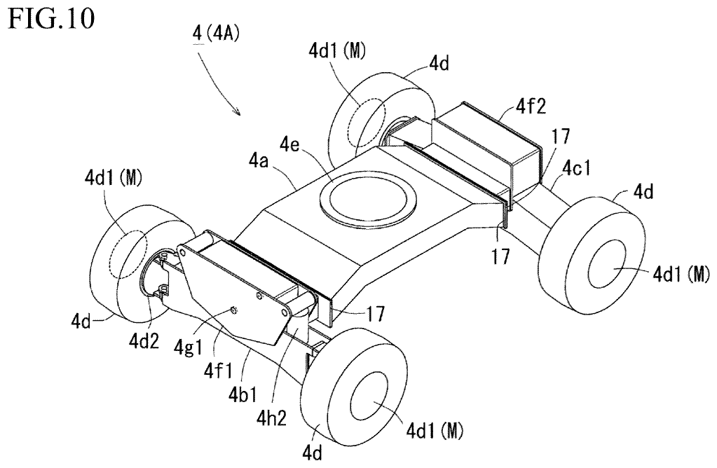

Next, other examples of the wheeled travel unit 4A and the crawler-type travel unit 4B will be described. First, the wheeled travel unit 4A will be described with reference to FIGS. 10 to 12. Note that members that are the same as those in the first embodiment have been assigned the same reference numerals in the following description, which will focus on configurations that are different.

In FIG. 10, a slewing bearing 4e is provided on the upper surface of the travel chassis 4a. Connecting portions (flange portions) 17 are provided on the front and rear end surfaces of the travel chassis 4a at opposite ends in the length direction. A mounting base 4f1 and a mounting base 4f2 are detachably attached to each connecting portion 17. The swing shafts 4g1 and 4g2 (not illustrated) are provided at center portions of these mounting bases 4f1 and 4f2, respectively. Note that the mounting bases 4f1 and 4f2 may be omitted, in which case the swing shafts 4g1, 4g2 may be provided on the travel chassis 4a. The wheels 4d are supported on the front swing axle 4b1 so as to be rotatable and steerable around the swing shafts 4g1, 4g2 by similar mechanisms to the mechanisms described in the first embodiment (see FIGS. 6A and 6B). The rear axle 4c has the wheels 4d rotatably supported at both ends of the rear swing axle 4c1. A travel motor M is connected to a hub 4d1 of each wheel 4d in the same way as in the first embodiment.

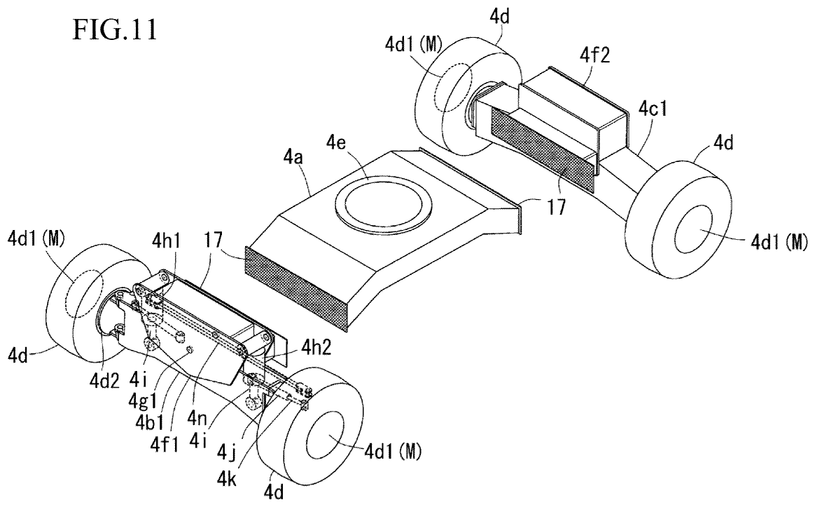

In FIG. 11, a pair of swing cylinders 4h1 and 4h2 are held on each of the mounting bases 4f1 and 4f2 (the mounting base 4h2 side is not illustrated). The cylinder rods 4i of the swing cylinders 4h1 and 4h2 are connected to both ends of the front swing axle 4b1 and the rear swing axle 4c1, respectively. Note that when the mounting bases 4f1 and 4f2 are omitted, the swing cylinders 4h1 and 4h2 may be provided on both sides of the travel chassis 4a.

As depicted in FIG. 17, hydraulic oil is supplied to the pair of swing cylinders 4h1 and 4h2 from the hydraulic unit 11 provided in the vehicle body frame 3, which causes each cylinder rod 4i to extend and retract. This supplying of hydraulic oil is stopped by controlling the opening and closing of a lock valve 11e provided in the hydraulic circuit.

As a result, even when the wheeled travel unit 4A travels on an uneven road surface as depicted in FIG. 17, the cylinder rods 4i of the swing cylinders 4h1 and 4h2 will extent and retract in keeping with the uneven surface, which causes the front swing axle 4b1 and the rear swing axle 4c1 to swing around the swing shafts 4g1 and 4g2, respectively, thereby maintaining a state where all four wheels are grounded so that a stable travel operation can be maintained. In addition, during work such as raising and lowering the raising/lowering unit 5, the lock valve 11e is closed to stop the supplying of hydraulic oil to the swing cylinders 4h1 and 4h2, so that any load (moment) generated by work, such as raising and lowering, is received by the four wheels that are grounded, which enables the work to be performed in a stable posture.

Note that the same configuration (see FIGS. 6A and 6B) is used whereby the orientations of the left and right front wheels 4d change when a steering handle provided in the basket 2 is operated and hydraulic oil is supplied from the hydraulic unit 11 inside the vehicle body frame 3 to the pair of steering cylinders 4j, which causes one cylinder rod 4k to extend and the other cylinder rod 4k to retract, thereby moving the steering rod 4n in either the left or right direction and causing the left and right knuckles 4d2 to rotate about the pins 4d3.

Although a travel motor M is connected to the inside of each of the four wheels 4d in the present embodiment, the travel motors M may be provided on only the front wheels 4d or on only the rear wheels 4d. The travel motors M may be hydraulic motors supplied with hydraulic oil from the hydraulic unit 11 or may be electric motors supplied with power from the battery 14.

FIG. 11 depicts a state where the mounting base 4f1 has been separated at the connecting portion (flange portion) 17 provided at the front end surface in the length direction of the travel chassis 4a to separate the front swing axle 4b1 and the front wheels 4d and a state where the mounting base 4f2 has been separated at the connecting portion (flange portion) 17 provided at the rear end surface in the length direction of the travel chassis 4a to separate the rear swing axle 4c1 and the rear wheels 4d.

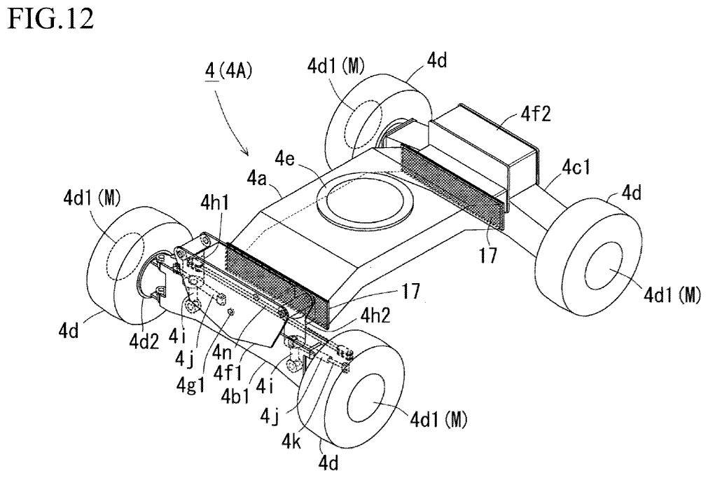

FIG. 12 depicts a state where the mounting base 4f1 has been connected at the connecting portion (flange portion) 17 provided at the front end surface in the length direction of the travel chassis 4a to attach the front swing axle 4b1 and the front wheels 4d and a state where the mounting base 4f2 has been connect at the connecting portion (flange portion) 17 provided at the rear end surface in the length direction of the travel chassis 4a to attach the rear swing axle 4c1 and the rear wheels 4d.

The connecting structure of the first connecting portions (connecting flanges) described above may take various forms. As examples, flange surfaces may be placed over each other and fastened by threading a bolt into bolt holes, or a clevis may be provided at facing flange portions which are connected and fastened with a pin. Alternatively, the flange surfaces may be connected by a combination of the above. The flange surfaces may be placed over each other, a bolt may be threaded into bolt holes, and hooks may be placed in engagement with engaged portions provided on the facing surfaces to connect the flange surfaces. As another configuration, the flange surfaces may be placed over each other, a bolt may be threaded into bolt holes, and claws may be inserted and placed in engagement with claw holes provided in the facing surfaces to connect the flange surfaces.

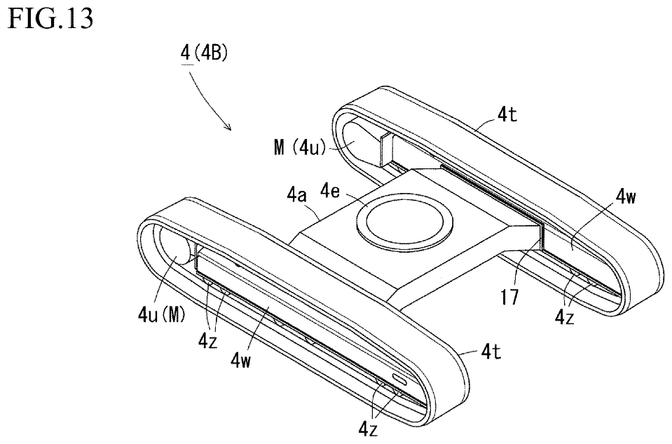

Next, another example of the crawler-type travel unit 4B will be described with reference to FIGS. 13 to 15. In FIG. 13, the crawler-type travel unit 4B is detachably assembled using the same connecting portions (flange portions) 17 that are provided on the front and rear end faces of the travel chassis 4a at opposite ends in the length direction. The crawler-type travel unit 4B is connected to the travel chassis 4a by placing side surface portions of the track frames 4w over the connecting portions 17. The connecting structure of the connecting portions 17 is the same as for the wheeled type and is covered by the description given earlier.

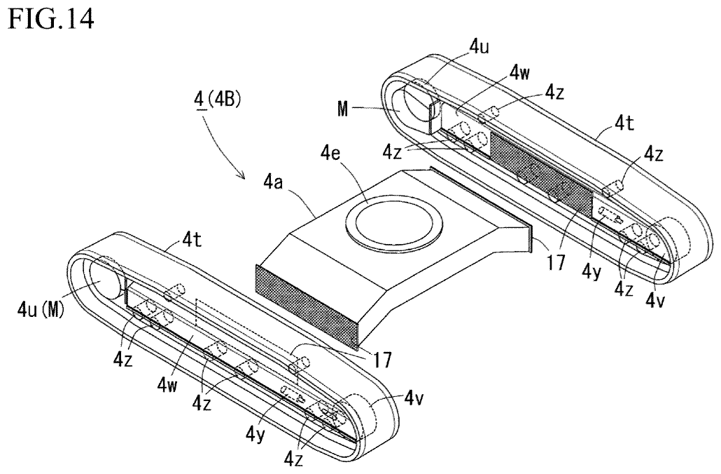

As depicted in FIG. 14, the crawler-type travel unit 4B has the same configuration as described earlier in that a drive wheel 4u and a driven wheel 4v are rotatably supported at both ends of each track frame 4w and a crawler 4t is suspended between the drive wheel 4u and the driven wheel 4v. Each track frame 4w also has the same configuration as described earlier by being composed of a plurality of frames that fit together and are connected by an adjust cylinder 4y so as to be capable of extending and retracting, so that the spacing between a drive wheel 4u and a driven wheel 4v can be adjusted by operating an adjust cylinder 4y.

Note that in the present embodiment, a travel motor M is disposed coaxially with each drive wheel 4u. The travel motors M may be hydraulic motors supplied with hydraulic oil from the hydraulic unit 11, or may be electric motors supplied with power from the battery 14.

FIG. 14 depicts a state where the crawler-type travel unit 4B has been removed by separating the track frames 4w at connecting portions 17 provided on the front end surface and rear end surface of the travel chassis 4a at opposite ends in the length direction.

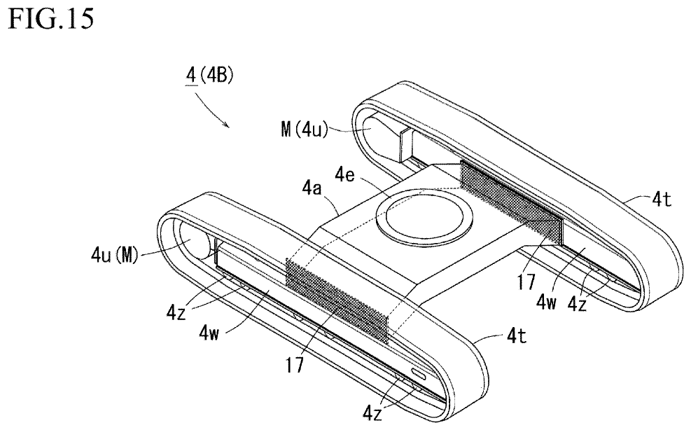

FIG. 15 depicts a state where the crawler-type travel unit 4B has been connected by placing side surface portions of the track frames 4w over the connecting portions 17 provided on the front end surface and rear end surface of the travel chassis 4a at opposite ends in the length direction.

As described above, by using the wheeled travel unit 4A on an even surface such as a paved road and using the crawler-type travel unit 4B on uneven ground, such as a job site, it is possible to make common use of the same travel chassis 4a and switch between the wheeled travel unit 4A and the crawler-type travel unit 4B in keeping with the usage environment, which makes it possible to reduce the vehicle cost and increase the operating efficiency of the aerial work vehicle 1. In particular, since the wheeled travel unit 4A and the crawler-type travel unit 4B can be switched at the same connecting portions 17 provided on the travel chassis 4a, the task of switching travel units can be simplified.

### Third Embodiment

Depending on the environment in which the aerial work vehicle 1 is used, obstacles may be present and it may be necessary to finely adjust the position of the basket 2.

In such cases also, in addition to switching the travel unit 4 between a wheeled and crawler type and the driving source between an engine and electric, if it were possible to switch between one of a front end connecting mechanism 20 and a front end jib connecting mechanism 21 at a position between the raising/lowering unit 5 and the basket 2, it would be possible to expand the range of options for the user and to reduce the equipment cost.

Note that in the following description, parts that are the same as in the first and second embodiments, such as the vehicle body frame 3, the travel unit 4, and the raising/lowering unit 5, have been assigned the same reference numerals and are covered by the description given earlier.

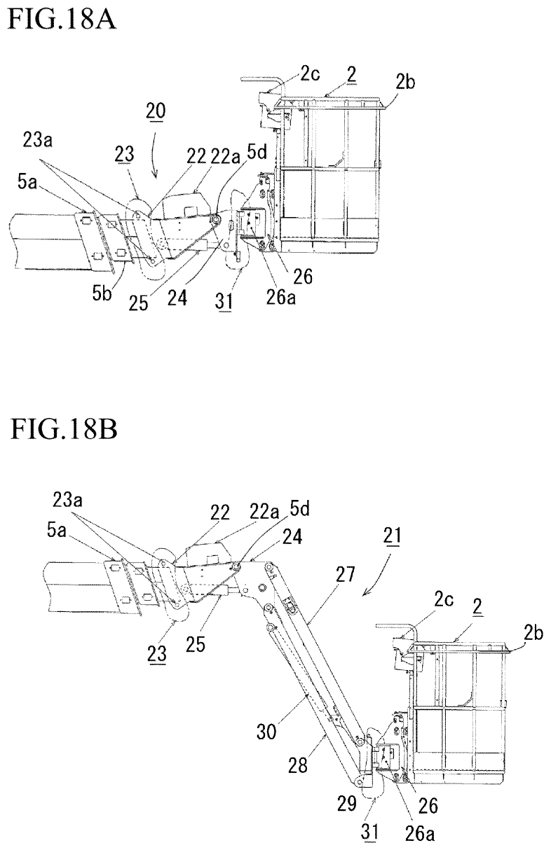

FIG. 18A is a diagram useful in explaining the front end connecting mechanism 20 that can be attached between the raising/lowering unit 5 and the basket 2. The second boom 5b that extends and retracts from the first boom 5a and a first end of a boom front end block 22 are detachably assembled at a front end first connecting portion 23. The other end of the boom front end block 22 is rotatably connected to a leveling bracket 24 by the rotational shaft 5d. A leveling cylinder 25 is connected between the boom front end block 22 and the leveling bracket 24. This leveling cylinder 25 keeps a front end part, including the basket 2, which is positioned closer to the front end than the leveling bracket 24 in a horizontal posture in response to operations of the raising/lowering unit 5. A control valve 22a is also provided on the boom front end block 22. The control valve 22a opens and closes a valve to supply hydraulic pressure to an actuator, such as the leveling cylinder 25. The leveling bracket 24 is detachably attached to a basket support bracket 26 at a front end second connecting portion 31. The basket support bracket 26 holds a basket slewing actuator 26a that slews the basket 2 to the left and right. When there are no obstacles in the periphery of the basket 2, this front end connecting mechanism 20 can be installed between the raising/lowering unit 5 and the basket 2, which makes it possible to use a simpler configuration for the aerial work vehicle 1.

FIG. 18B is a diagram useful in explaining the front end jib connecting mechanism 21 that can be attached between the raising/lowering unit 5 and the basket 2. Members that are the same as those appearing in FIG. 18A have been assigned the same reference numerals and are covered by the description given above. The second boom 5b, which extends and retracts from the first boom 5a, and the first end of the boom front end block 22 are detachably assembled at the front end first connecting portion 23. The other end of the boom front end block 22 is rotatably connected to the leveling bracket 24 by the rotational shaft 5d. The leveling cylinder 25 is connected between the boom front end block 22 and the leveling bracket 24. The boom front end block 22 is also provided with the control valve 22a. First ends of a pair of jib booms 27 and a pair of jib links 28 are rotatably connected to the leveling bracket 24, and the other ends of the pair of jib booms 27 and the pair of jib links 28 are rotatably connected to a connecting link 29. The pair of jib booms 27 and the pair of jib links 28 are connected by a jib cylinder 30. By operating the jib cylinder 30, the pair of jib booms 27 can be raised and lowered in the vertical direction. The leveling cylinder 25 also keeps a front end part, which here includes the pair of jib booms 27 and the basket 2, which is located closer to the front end than the leveling bracket 24, in a horizontal posture in response to the operations of the raising/lowering unit 5. The connecting link 29 and the basket support bracket 26 are removably assembled at the front end second connecting portion 31. The basket support bracket 26 holds a basket slewing actuator 26a that slews the basket 2 to the left and right. If there are obstacles in the periphery of the basket 2 or fine adjustment of the basket position is required, the front end jib connecting mechanism 21 can be installed between the raising/lowering unit 5 and the basket 2, which makes it possible to use an aerial work vehicle 1 which greater maneuverability.

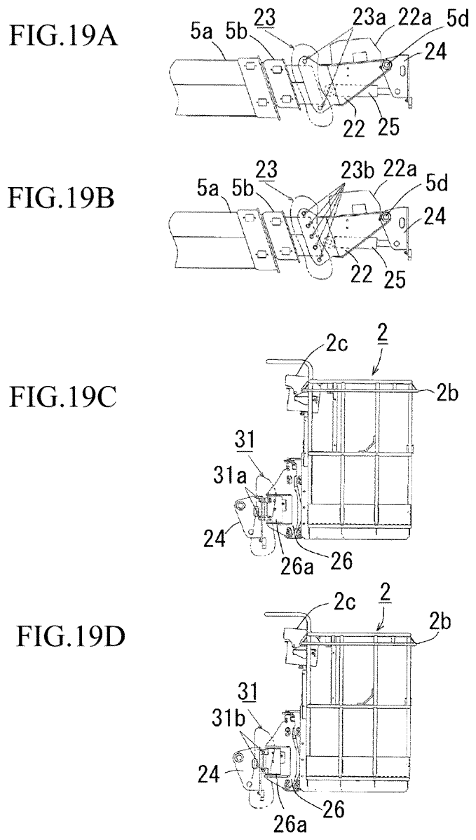

An example configuration of the front end first connecting portion 23 is depicted in FIGS. 19A and 19B, and an example configuration of the front end second connecting portion 31 is depicted in FIGS. 19C and 19D.

As depicted in FIG. 19A, the front end first connecting portion 23 may connect and fix the front end of the second boom 5b and the boom front end block 22 using a connecting pin 23a, or as depicted in FIG. 19B, the front end of the second boom 5b and the boom front end block 22 may be connected and fixed by a plurality of bolts 23b.

As depicted in FIG. 19C, the front end second connecting portion 31 may be configured such that the leveling bracket 24 and the basket support bracket 26 are connected and fixed by a plurality of bolts 31a, or as depicted in FIG. 19D, the leveling bracket 24 and the basket support bracket 26 may be connected and fixed by a connecting pin 31b. Note that although fixing pins and bolts have been depicted as example configurations of the front end first connecting portion 23 and the front end second connecting portion 31, attachment and detachment can be achieved using another connecting structure (such as by fitting convex and concave parts together).

Note also that although the front end second connecting portion 31 has been described as having a structure that makes common use of the configuration of the front end first connecting portion 23 but adds extra parts, such first and second connecting portions may use common parts or different parts.

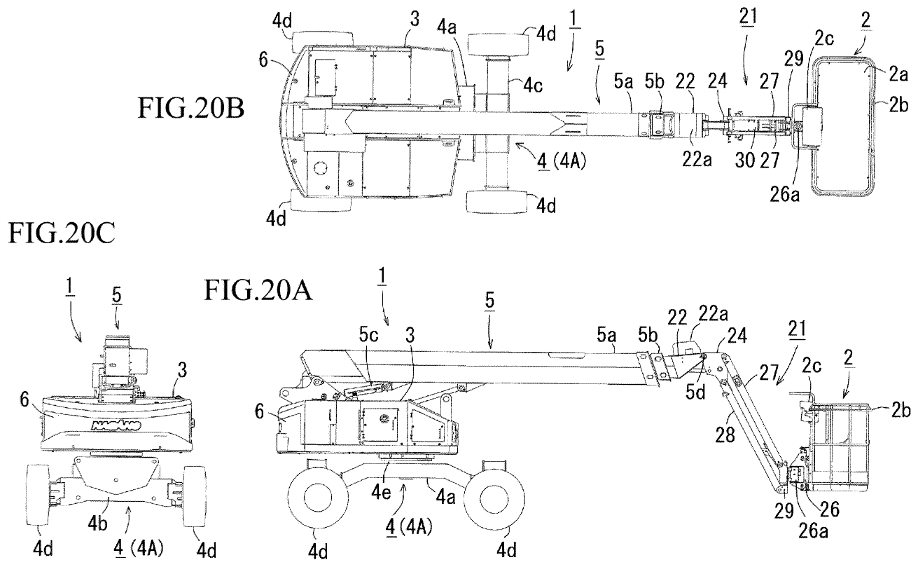

FIGS. 20A to 20C depict an embodiment of the aerial work vehicle 1 where the wheeled travel unit 4A is combined with the front end jib connecting mechanism 21. Members that are the same as the aerial work vehicle 1 depicted in FIGS. 1A to 1C have been assigned the same reference numerals and are covered by the description given earlier. Note that either the engine drive unit 7 or the electric drive unit 13 may be used as the driving source of the hydraulic unit (see FIG. 16). The vehicle body frame 3 is slewably mounted on the travel unit 4 that uses the wheeled travel unit 4A. The raising/lowering unit 5 is mounted on the vehicle body frame 3, with the raising/lowering unit 5 including the first boom 5a that can be raised and lowered and the second boom 5b that can be extended and retracted relative to the first boom 5a in a concentric arrangement. The front end jib connecting mechanism 21 is installed between the raising/lowering unit 5 and the basket 2 (see FIGS. 20A and 20B). The wheeled travel unit 4A is preferably used on smoothed surfaces, such as a paved road. When obstacles are present in the periphery of the basket 2 or when fine adjustment of the basket position is necessary, it is preferable to use the front end jib connecting mechanism 21. In addition to being able to raise and lower the basket 2 by raising and lowering the first boom 5a and extending and retracting the second boom 5b relative to the first boom 5a, by operating the jib cylinder 30, it is possible to raise and lower the jib boom 27 and the jib link 28 to raise and lower the basket 2, and by operating the leveling cylinder 25, the horizontal posture of a part that is closer to the front end than the leveling bracket 24 and includes the basket 2 can be maintained. By doing so, it is possible for the basket 2 to easily pass over and go around obstacles, and also possible to perform fine adjustment of the basket position at height.

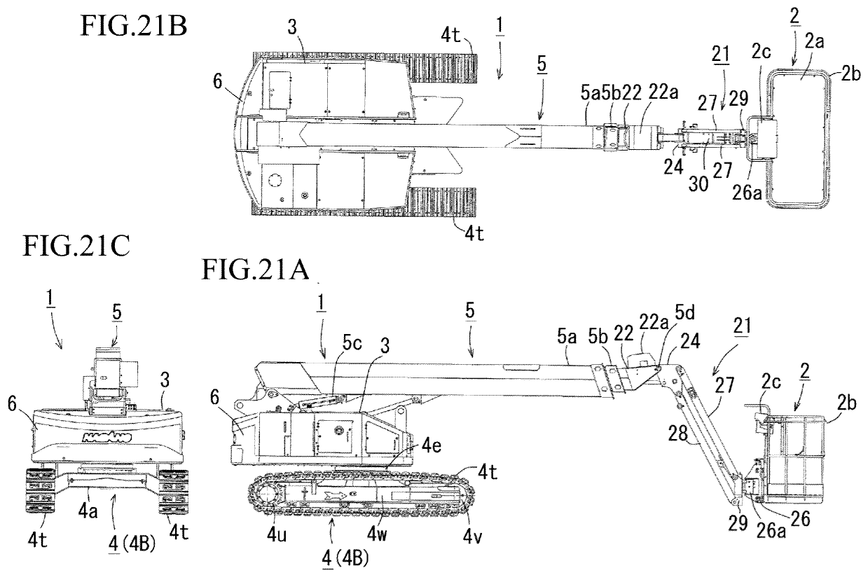

FIGS. 21A to 21C depict an embodiment of the aerial work vehicle 1 where the front end jib connecting mechanism 21 is combined with the crawler-type travel unit 4B. Members that are the same as the aerial work vehicle 1 depicted in FIGS. 2A to 2C have been assigned the same reference numerals and are covered by the description given earlier. Note that either the engine drive unit 7 or the electric drive unit 13 may be used as the driving source for the hydraulic unit (see FIG. 16). The vehicle body frame 3 is slewably mounted on the travel unit 4, which uses the crawler-type travel unit 4B. The raising/lowering unit 5 is mounted on the vehicle body frame 3, with the raising/lowering unit 5 including the first boom 5a that can be raised and lowered and the second boom 5b that can be extended and retracted relative to the first boom 5a in a concentric arrangement. The front end jib connecting mechanism 21 is installed between the raising/lowering unit 5 and the basket 2 (see FIGS. 21A and 21B). The crawler-type travel unit 4B is preferably used on uneven ground such as a building site. When obstacles are present in the periphery of the basket 2 or when fine adjustment of the basket position is necessary, it is preferable to use the front end jib connecting mechanism 21. In this case also, the basket 2 can easily pass over and go around obstacles, and fine adjustment of the basket position is possible at height.

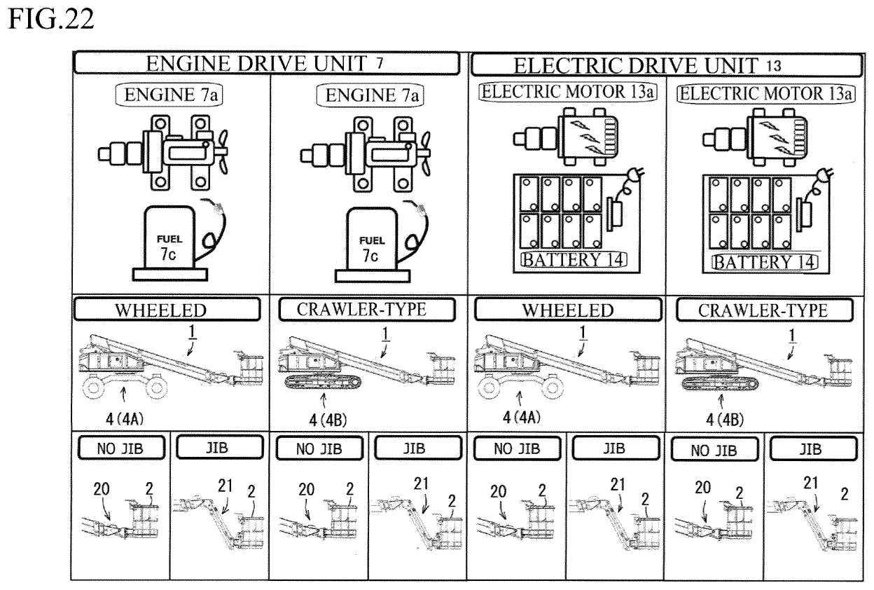

FIG. 22 is a diagram useful in collectively depicting usage setups of the aerial work vehicle 1 when the driving source inside the vehicle body frame 3 is switched between the engine drive unit 7 and the electric drive unit 13, when the travel unit 4 is switched between the wheeled travel unit 4A and the crawler-type travel unit 4B, and switching is performed between the front end connecting mechanism 20 and the front end jib connecting mechanism 21. Note that in FIG. 22, configurations equipped with the front end connecting mechanism 20 are indicated as “no jib” and configurations equipped with the front end jib connecting mechanism 21 are indicated as “jib”.

When the usage environment is a work site without electrical power supplying equipment, in high temperature environments where the outside temperature exceeds 40° C., and in low temperature environments where the outside temperature is 0° C. or below, it is possible to use an aerial work vehicle 1 that includes the engine drive unit 7 and is equipped with the wheeled travel unit 4A or the crawler-type travel unit 4B depending on differences in the running surface. At indoor work sites where exhaust gas emissions are not permitted, in urban areas with noise regulations, or at nighttime work sites, it is possible to use an aerial work vehicle 1 that includes the electric drive unit 13 and is equipped with the wheeled travel unit 4A or the crawler-type travel unit 4B depending on differences in the running surface.

When obstacles may be present or it is desirable to make fine adjustments to the position of the basket 2, it is possible to use an aerial work vehicle 1 where the travel unit 4 is wheeled or a crawler type, where the driving source is an engine or is electric, and one of the front end connecting mechanism 20 and the front end jib connecting mechanism 21 is installed between the raising/lowering unit 5 and the basket 2.

In this way, the same aerial work vehicle 1 can be used to increase the variations of vehicle depending on the usage environment, including the state of the running surface, which improves usability, reduces the vehicle cost, and improves operating efficiency.

1. An aerial work vehicle that can accommodate a worker in a basket provided at a front end of a raising/lowering boom and is capable of travelling, raising/lowering, and slewing operations, the aerial work vehicle comprising:
a vehicle body frame including a hydraulic unit, which supplies hydraulic oil to each operated unit provided in a vehicle, and a main counterweight, which provides a stabilizing mass for a tipping mass that acts on the vehicle;
a raising/lowering unit that is mounted on the vehicle body frame and is supplied with hydraulic oil by the hydraulic unit to raise and lower the raising/lowering boom and move the basket supported at a front end of the boom to a desired height; and
a travel unit that supports the body frame so as to be capable of slewing and travels on a running surface,
wherein the travel unit is switchably combined with one of:
a wheeled travel unit in which connecting axles for holding wheels are detachably connected to first connecting portions provided at intermediate positions on a front axle and a rear axle disposed on the travel chassis; and
a crawler-type travel unit in which track frames, each of which supports a drive wheel and a driven wheel on which a crawler is suspended, are detachably connected to second connecting portions provided on side surfaces of the travel chassis.

2. An aerial work vehicle that can accommodate a worker in a basket provided at a front end of a raising/lowering boom and is capable of travelling, raising/lowering, and slewing operations, the aerial work vehicle comprising:
a vehicle body frame including a hydraulic unit, which supplies hydraulic oil to each operated unit provided in a vehicle, and a main counterweight, which provides a stabilizing mass for a tipping mass that acts on the vehicle;
a raising/lowering unit that is mounted on the vehicle body frame and is supplied with hydraulic oil by the hydraulic unit to raise and lower the raising/lowering boom and move the basket supported at a front end of the boom to a desired height; and
a travel unit that supports the body frame so as to be capable of slewing and travels on a running surface,
wherein the travel unit is switchably combined, at a same set of connecting portions provided on opposite surfaces of a travel chassis, with one of:
a wheeled travel unit in which a front axle and a rear axle that hold wheels at both ends are respectively connected; and
a crawler-type travel unit including track frames, each of which supports a drive wheel and a driven wheel on which a crawler is suspended.

3. The aerial work vehicle according to claim 1,
wherein in the crawler-type travel unit, each track frame is composed of a plurality of frames that fit together and are connected by an adjust cylinder so as to be capable of extending and retracting, and a spacing between the drive wheel and the driven wheel is adjustable by operating the adjust cylinder.

4. The aerial work vehicle according to claim 1,
wherein in the wheeled travel unit, a front swing axle and a rear swing axle are each supported so as to be capable of swinging about swing shafts provided on the travel chassis, and cylinder rods of a pair of swing cylinders supported on both sides of the travel chassis are connected to both ends of the front swing axle and the rear swing axle.

5. The aerial work vehicle according to claim 1,
wherein travel motors are connected to the wheeled travel unit and the drive wheels of the crawler-type travel unit.

6. The aerial work vehicle according to claim 1,
wherein a counterweight is mounted on a second mounting portion when an engine drive unit has been mounted on a first mounting portion of the vehicle body frame, and a battery is mounted on the second mounting portion when an electric drive unit has been mounted on the first mounting portion.

7. The aerial work vehicle according to claim 1,
wherein between a front end portion of the raising/lowering boom and the basket, one of:
a front end connecting mechanism in which a leveling bracket is rotatably connected to a boom front end block and which keeps the basket in a horizontal posture using a leveling cylinder that connects the boom front end block and the basket; and
a front end jib connecting mechanism which, in addition to the front end connecting mechanism, has the basket connected via a pair of jib booms and a pair of jib links that are rotatably connected to the leveling bracket and in which the jib booms are raisable by a jib cylinder that connects the jib booms and the jib links,
is installed.

8. The aerial work vehicle according to claim 2,
wherein in the crawler-type travel unit, each track frame is composed of a plurality of frames that fit together and are connected by an adjust cylinder so as to be capable of extending and retracting, and a spacing between the drive wheel and the driven wheel is adjustable by operating the adjust cylinder.

9. The aerial work vehicle according to claim 2,
wherein in the wheeled travel unit, a front swing axle and a rear swing axle are each supported so as to be capable of swinging about swing shafts provided on the travel chassis, and cylinder rods of a pair of swing cylinders supported on both sides of the travel chassis are connected to both ends of the front swing axle and the rear swing axle.

10. The aerial work vehicle according to claim 2,
wherein travel motors are connected to the wheeled travel unit and the drive wheels of the crawler-type travel unit.

11. The aerial work vehicle according to claim 2,
wherein a counterweight is mounted on a second mounting portion when an engine drive unit has been mounted on a first mounting portion of the vehicle body frame, and a battery is mounted on the second mounting portion when an electric drive unit has been mounted on the first mounting portion.

12. The aerial work vehicle according to claim 2,
wherein between a front end portion of the raising/lowering boom and the basket, one of:
a front end connecting mechanism in which a leveling bracket is rotatably connected to a boom front end block and which keeps the basket in a horizontal posture using a leveling cylinder that connects the boom front end block and the basket; and
a front end jib connecting mechanism which, in addition to the front end connecting mechanism, has the basket connected via a pair of jib booms and a pair of jib links that are rotatably connected to the leveling bracket and in which the jib booms are raisable by a jib cylinder that connects the jib booms and the jib links,
is installed.
